(19) United States
(12) Patent Application Publication
(10) Pub. No.: US 2013/0234408 A1
(43) Pub. Date: Sep. 12, 2013

(54) MOBILE WORKING STATION

(71) Applicant: VICKIE CHILDERS, Round-O, SC (US)

(72) Inventor: VICKIE CHILDERS, Round-O, SC (US)

(21) Appl. No.: 13/414,715

(22) Filed: Mar. 7, 2012

(51) Int. Cl. B62B 1/10; B65D 25/02; B65D 25/28

(52) U.S. Cl. 280/47.17; 220/23.83

(57) ABSTRACT

A mobile working station comprising a first container, where the first container includes an inner cavity; a pair of handlebars extending from the first container, where the pair of handlebars meet at a handle; a pair of brackets attached to the handlebars, where the pair of brackets support a platform; and a second container positioned within the inner cavity of the first container, where the second container receives a plurality of office supplies. The handle may include a comfort grip, and may be telescopic to enable the user to adjust the height. Finally, the mobile working station may include a set of all terrain wheels for greater transportability.

### BACKGROUND OF THE INVENTION

1. Field of Invention

The present invention relates to a mobile working station that transports work supplies in an office environment.

2. Description of Related Art

Certain professionals are required to transport essential supplies such as a computer, notebook, documents, files, and writing supplies with them at all times. Similarly, students often have to carry their books, computers, notebooks and pens with them from class to class, sometimes requiring two bags to fit all of their belongings. Students may find this especially problematic if they have a class in one building and then must quickly get to another building before their next class without time to stop at a locker or vehicle to unload or exchange some of their belongings. With all of these items the person is heavily burdened as they walk from one place to another due to the extreme weight of their supplies. Over time this may cause back problems, knee aches, or even headaches due to the excessive weight carried.

Unfortunately, there are limited alternatives to shoulder bags and backpacks that avoid the hassles of limited accessibility, a lack of support and stability, and shoulder/arm pain resulting from a heavy bag. The person is often simply forced to endure the stress and burden of the bag. There exists a need in the art to provide a way to easily transport the supplies and files without having to carry all the items on the user's back or shoulder.

### SUMMARY OF THE INVENTION

In view of the foregoing disadvantages inherent in the prior art, the general purpose of the present invention is to provide a mobile working station.

Accordingly, an object of the present invention is to provide a working station that enables a user to easily transport their work items in convenient, wheeled, storage unit, thereby alleviating the user from having to carry all of their working essentials.

To achieve the above objects, in an aspect of the present invention, a mobile working station is described comprising a first container, where the first container includes an inner cavity; a pair of handlebars extending from the first container, where the pair of handlebars meet at a handle; a pair of brackets attached to the handlebars, where the pair of brackets support a platform; and a second container positioned within the inner cavity of the first container, where the second container receives a plurality of office supplies. The handle may include a comfort grip, and may be telescopic to enable the user to adjust the height. Finally, the mobile working station may include a set of all terrain wheels for greater transportability.

These together with other aspects of the present invention, along with the various features of novelty that characterize the present invention, are pointed out with particularity in the claims annexed hereto and form a part of this present invention. For a better understanding of the present invention, its operating advantages, and the specific objects attained by its uses, reference should be made to the accompanying drawings and descriptive matter in which there are illustrated exemplary embodiments of the present invention.

### BRIEF DESCRIPTION OF DRAWINGS

The advantages and features of the present invention will become better understood with reference to the following detailed description and claims taken in conjunction with the accompanying drawings, wherein like elements are identified with like symbols, and in which:

FIG. 1A illustrates a perspective view of a plurality of components of a mobile working station, according to the present invention; and

FIG. 1B illustrates a perspective view of an assembled mobile working station, according to the present invention.

### DETAIL DESCRIPTION

The present invention relates to a mobile working station that transports work supplies in an office environment. The mobile working station comprises multiple storage areas for a user to place their belongings, including a platform upon which the user may rest their laptop computer. The mobile working station includes set of wheels for easy transporting, along with a handle for steering and maneuvering the station. By placing the user's everyday desk items within the mobile working station the user is better afforded the ability to move around while they work, and are relieved from having to carry all of their items on their back.

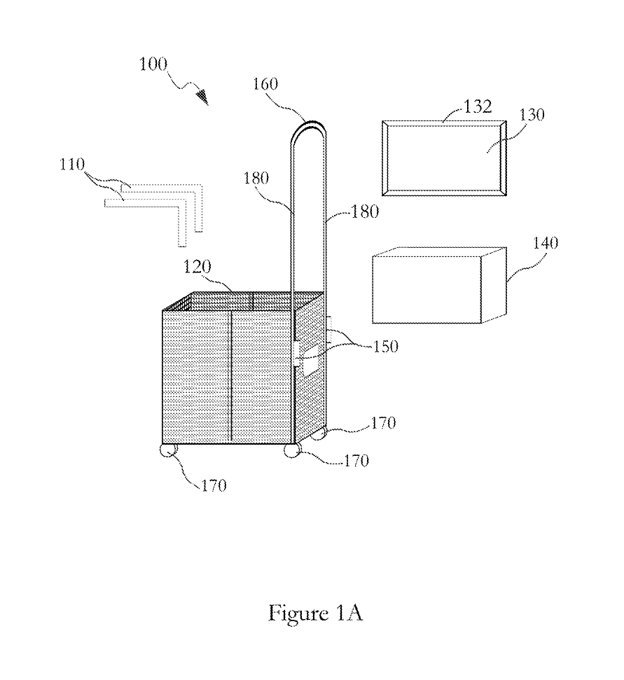

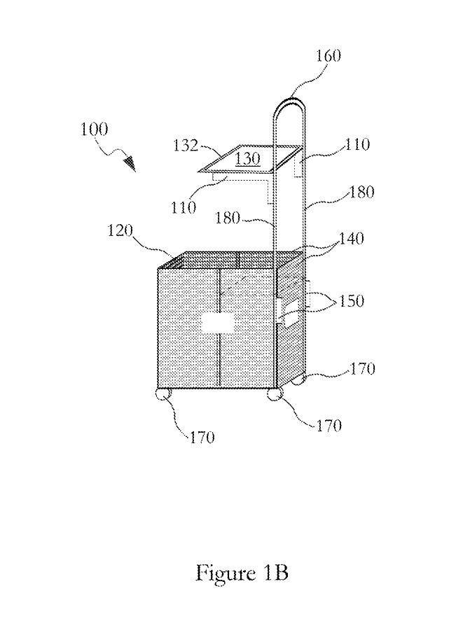

Turning now descriptively to the drawings FIG. 1A illustrates a perspective view of a plurality of components a mobile working station 100 in accordance with the present invention. The mobile working station 100 may generally include a pair of brackets 110, a first container 120, a platform 130, a second container 140 and a handle 160. A set of wheels 170 may be attached beneath the first container 120. The set of wheels 170 may be all terrain wheels to enable the user to wheel the mobile working station 100 over a variety of different surfaces, with the capacity to hold heavy weight, which increases the portability of larger, yet needed items.

The platform 130 may include a lip 132 around the peripheral edge of the platform 130 to prevent items placed on the platform 130 from falling off.

The handle 160 may extend from the first container 120 upon a set of handle bars 180. The handle bars 180 may raise and lower with an adjustment means 150. The adjustment means 150 may be a peg lock device to enable the handle bars 180 to telescopically adjust the height of the handle 160. The handle 160 may be covered with a comfort grip material to provide a softer gripping surface for the user.

Referring now to FIG. 1B, a diagonal front side perspective view of an assembled mobile working station 100 is shown in accordance with the present invention. As illustrated the second container 140 is positioned within the inner cavity of the first container 120. The first container 120 and the second container 140 may comprise complementary rectangular or square shapes to accommodate a plurality of school and office supplies. For example, the user may place their files, folders, binders and notebooks in the first container 120, and then place pens, pencils, envelopes, coupons, paper, white out, books or tape in the second container 140. The first container 120 and the second container 140 may be made from a variety of durable, rigid materials such as plastic, aluminum, wicker, wood or the like.

Attached to the handlebars 180 may be the brackets 110. The brackets 110 support the platform 130 next to the handle 160. The platform 130 provides a convenient computer tray upon which the user may rest their laptop computer. Alternatively, if the user is giving a presentation the platform 130 may serve as a pedestal to rest models, visual aids, prototypes or the like. The lip 132 serves to prevent the laptop or other items on the platform 130 from sliding or falling. When the handlebars 180 are in the most refracted position or shortest handle height, the platform 130 may rest directly above the second container 140, serving as a lid for the second container 140.

The mobile working station 100 is a portable working station that allows a user to transport working supplies to various locations in a convenient and comfortable manner, making it easy to conduct presentations, meetings, or hold multiple appointments throughout the day. The platform 130 provides a stable surface on which a computer can be used thereby increasing productivity and ease of use at home, the office, school, or business. The mobile working station 100 is readily available at office supply retail stores.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

1. A mobile working station comprising:
a first container, where said first container includes an open top and where said first container includes an inner cavity;
a set of handlebars extending vertically from said first container, where said set of handlebars meet at a handle, where said handle includes a comfort grip surface;
an adjustment means within said set of handlebars, where said adjustment means allows said handlebars to be telescopic thereby changing the height of said handle to accommodate a plurality of users;
a pair of brackets attached to said set of handlebars, where said pair of brackets support a platform; and
a second container positioned within the inner cavity of said first container, where said second container receives a plurality of office supplies.

2. (canceled)

3. (canceled)

4. (canceled)

5. The mobile working station according to claim 1, wherein said first container includes a set of wheels.

6. The mobile working station according to claim 5, wherein said set of wheels are all terrain wheels.

7. The mobile working station according to claim 1, wherein said platform includes a lip around the peripheral edge of said platform.
